(19) United States
(12) Patent Application Publication
(10) Pub. No.: US 2020/0026614 A1
(43) Pub. Date: Jan. 23, 2020

(54) METHOD AND SYSTEM FOR DYNAMIC DATA PROTECTION

(71) Applicant: EMC IP Holding Company LLC, Hopkinton, MA (US)

(72) Inventor: Anand Rudrabhatla, Pleasanton, CA (US)

(21) Appl. No.: 16/041,995

(22) Filed: Jul. 23, 2018

(51) Int. Cl. G06F 11/14; G06F 17/30

(52) U.S. Cl. CPC G06F 11/1453; G06F 2201/84; G06F 17/30156

(57) ABSTRACT

A method and system for dynamic data protection. Specifically, the method and system disclosed herein provide and manage tiers of licensed storage capacity on which backup data may be consolidated. The particular tier of licensed storage capacity on which backup data may be consolidated may be dependent on the characteristics of the backup data. In cases where there may be insufficient available capacity in a licensed storage capacity tier to consolidate the backup data, a remaining capacity lacking in the licensed storage capacity tier may be overdrawn from another licensed storage capacity tier, provided that the latter tier has enough unallocated capacity to subsume the lacking capacity.

### BACKGROUND

Various forms of data are often submitted for backup consolidation across various remote storage systems or media. Further, frequently, the data may be consolidated irrespective of their characteristics (e.g., their data deduplication compatibility).

### BRIEF DESCRIPTION OF DRAWINGS

FIG. 1 shows a system in accordance with one or more embodiments of the invention.

FIG. 2A shows a backup storage system in accordance with one or more embodiments of the invention.

FIG. 2B shows a logical storage pool in accordance with one or more embodiments of the invention.

FIGS. 3A-3C show flowcharts describing a method for dynamically managing storage capacity in accordance with one or more embodiments of the invention.

FIG. 4 shows a computing system in accordance with one or more embodiments of the invention.

FIGS. 5A-5C show an example scenario in accordance with one or more embodiments of the invention.

### DETAILED DESCRIPTION

Specific embodiments of the invention will now be described in detail with reference to the accompanying figures. In the following detailed description of the embodiments of the invention, numerous specific details are set forth in order to provide a more thorough understanding of the invention. However, it will be apparent to one of ordinary skill in the art that the invention may be practiced without these specific details, In other instances, well-known features have not been described in detail to avoid unnecessarily complicating the description.

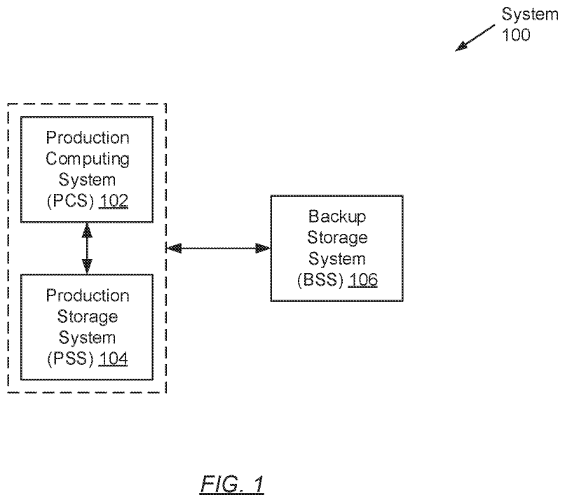

In the following description of FIGS. 1-5C, any component described with regard to a figure, in various embodiments of the invention, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components, Additionally, in accordance with various embodiments of the invention, any description of the components of a figure is to be interpreted as an optional embodiment which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to necessarily imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and a first element may encompass more than one element and succeed (or precede) the second element in an ordering of elements.

In general, embodiments of the invention relate to a method and system for dynamic data protection. Specifically, towards implementing dynamic data protection, one or more embodiments of the invention provide and manage tiers of licensed storage capacity on which backup data may be consolidated. Further, the particular tier of licensed storage capacity on which backup data may be consolidated may be dependent on the characteristics of the backup data. Moreover, in embodiments where there may be insufficient available capacity in a licensed storage capacity tier to consolidate the backup data, a remaining capacity lacking in the licensed storage capacity tier may be overdrawn from another licensed storage capacity tier, provided that the latter tier has enough unallocated capacity to subsume the lacking capacity.

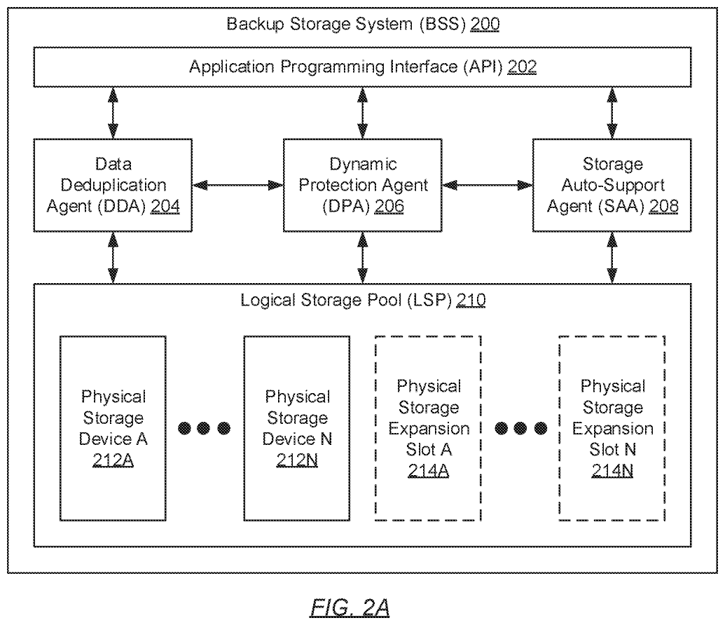

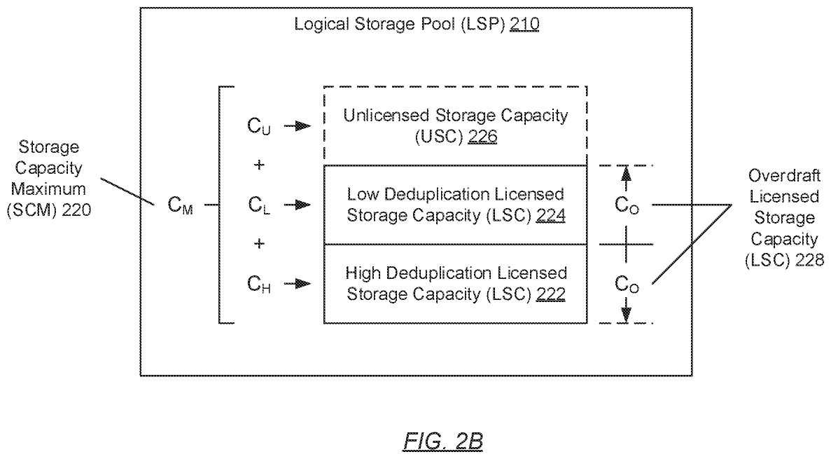

One or more embodiments of the invention hereinafter may be described with respect to consolidating deduplicated data on either high deduplication licensed storage capacity (LSC) or low deduplication LSC (see e.g., FIG. 2B). However, one of ordinary skill will appreciate that the invention may be practiced using LSC partitioned by other factors such as, for example, different tiered performance capacity.

FIG. 1 shows a system in accordance with one or more embodiments of the invention. The system (100) may include a production computing system (PCS) (102) operatively connected to a production storage system (PSS) (104). Further, both the PCS (102) and the PSS (104) may be operatively connected to a backup storage system (BSS) (106). Each of these components is described below.

In one embodiment of the invention, the aforementioned components may be directly or indirectly connected to one another through a network (e.g., a local area network (LAN), a wide area network (WAN) such as the Internet, a mobile network, or any other network) (not shown). The network may be implemented using any combination of wired and/or wireless connections, In embodiments in which the aforementioned components are indirectly connected, there may be other networking components or systems (e.g., switches, routers, gateways, etc.) that facilitate communication, information exchange, and/or resource sharing. Further, the aforementioned components may communicate with one another using any combination of wired and/or wireless communication protocols.

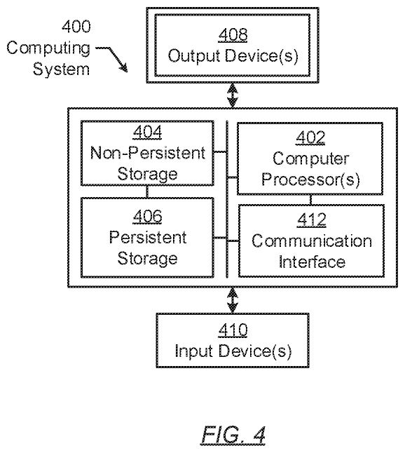

In one embodiment of the invention, the PCS (102) may be any computing system (see e.g., FIG. 4) used for various applications. These applications may, for example, require large-scale and complex data processing. In one embodiment of the invention, the PCS (102) may be any computing system that may serve multiple users concurrently, Further, the PCS (102) may be programmed to provide and manage the allocation of computing resources (e.g., computer processors, memory, persistent and non-persistent storage, network bandwidth, etc) towards the execution of various processes (or tasks) that may be instantiated by one or more users and/or operating systems (OSs). Moreover, the PCS (102) may include additional functionality to submit data storage requests, enclosing data, to the BSS (106) for backup consolidation and/or archiving; and receive acknowledgements and alerts back from the BSS (106) based on the processing of the submitted data storage requests. Examples of the PCS (102) include, but are not limited to, one or more: desktop computers, laptop computers, smartphones, tablet computers, gaming consoles, servers, mainframes, or any combination thereof.

in one embodiment of the invention, the PSS (104) may represent one or more physical storage devices and/or media on which various forms of information, pertinent to the PCS (102), may be consolidated. The one or more physical storage devices and/or media may or may not be of the same type. Further, information consolidated in the PSS (104) may be arranged using any storage mechanism (e.g., a filesystem, a collection of tables or records, etc.). In one embodiment of the invention, the PSS (104) may be implemented using persistent (i.e., non-volatile) storage. Examples of persistent storage include, but are not limited to: optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM).

In one embodiment of the invention, the BSS (106) may refer to a data backup, archiving, and/or disaster recovery (DR) storage system. The BSS (106) may be implemented using one or more servers (not shown). Each server may be a physical server (i.e., residing in a datacenter) or a virtual server (i.e., residing in a cloud computing environment). In one embodiment of the invention, the BSS (106) may be implemented on one or more computing systems similar to the exemplary computing system shown in FIG, 4. The BSS (106) is described in further detail below with respect to FIG. 2A.

While FIG. 1 shows a configuration of components, other system configurations may be used without departing from the scope of the invention. For example, the system (100) may further include one or more user clients (not shown) or any computing system (see e.g., FIG. 4) operated by a user of the PCS (102). A user of the PCS (102) may refer to an individual, a group of individuals, or an entity that may submit jobs or tasks to be processed by/on the PCS (102).

FIG. 2A shows a backup storage system (BSS) in accordance with one or more embodiments of the invention. As described above, the BSS (200) may serve as a data backup, archiving, and/or disaster recovery storage system. To that end, the BSS (200) may include an application programming interface (API) (202), a data deduplication agent (DDA) (204), a dynamic protection agent (DPA) (206), a storage auto-support agent (SAA) (208), and a logical storage pool (LSP) (210). Each of these components is described below.

In one embodiment of the invention, the API (202) may be a hardware and/or software implemented construct that employs a set of subroutine definitions, protocols, and/or tools for enabling communications between the BSS (200) and one or more external entities (e.g., the production computing system (PCS) (not shown)). The API (202) may include functionality to: receive data storage requests; delegate the data storage requests to the DPA (206); provide a portal through which analytics, generated by the SAA (208), pertaining to the LSP (210) may be accessed by the one or more external entities (e.g., the PCS (not shown), one or more user clients (not shown), etc.); receive alerts based on the processing of the received data storage requests by/frons the DDA (204), the DPA (206), and/or. the SAA (208); and transmit any alerts to the request submitter(s) (e.g., the PCS (not shown)). One of ordinary skill will appreciate that the API (202) may perform other functionalities without departing from the scope of the invention. By way of an example, the API (202) may be a web API that may be accessed through an assigned web address (e.g., a uniform resource locator (URL)) and a WAN (e.g., Internet) connection.

In one embodiment of the invention, the DDA (204) may be a computer program or process(i.e., an instance of a computer program) that executes on the underlying hardware of the BSS (200). Specifically, the DDA (204) may be a computer program or process tasked with the deduplication of data submitted for consolidation onto the BSS (200). In short, deduplication may refer to a data compression technique directed at eliminating duplicate data blocks (or chunks). Substantively, through deduplication, only the unique data blocks (or chunks) of any particular data may be consolidated. To that end, the DDA (204) may include functionality to: receive original (i.e., non-deduplicated) data from the DPA (206); apply one or more known deduplication algorithms on the original data to render deduplicated data and a deduplication ratio; and provide the deduplicated data and deduplication ratio back to the DPA (206).

In one embodiment of the invention, deduplicated data, may encompass the compressed original data obtained following the deduplication process. The deduplication ratio, on the other hand, measures the effectiveness of the deduplication process on the original data on which the process had been applied. Further, the deduplication process may be determined by dividing the capacity required to store the data before the deduplication process (i.e., the capacity of the original data) by the capacity required to store the data after the deduplication process (i.e., the capacity of the deduplicated data). For example, an original dataset (before the deduplication. process) may require a capacity of 10 Terabytes (TB). The associated deduplicated data (after the deduplication process), however, may reduce the necessary capacity to 1 TB. The resulting deduplication ratio would be 10:1 and would thus render a ninety percent (90%) savings in the required capacity to store the data.

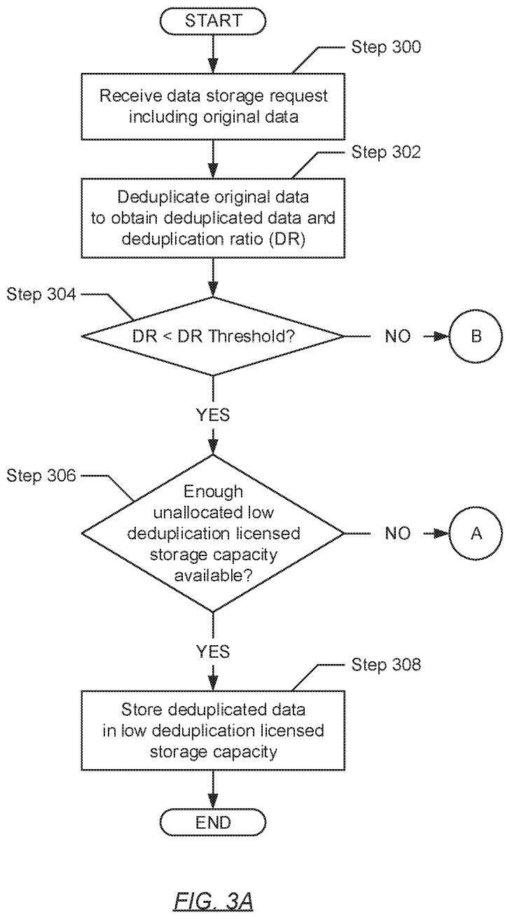

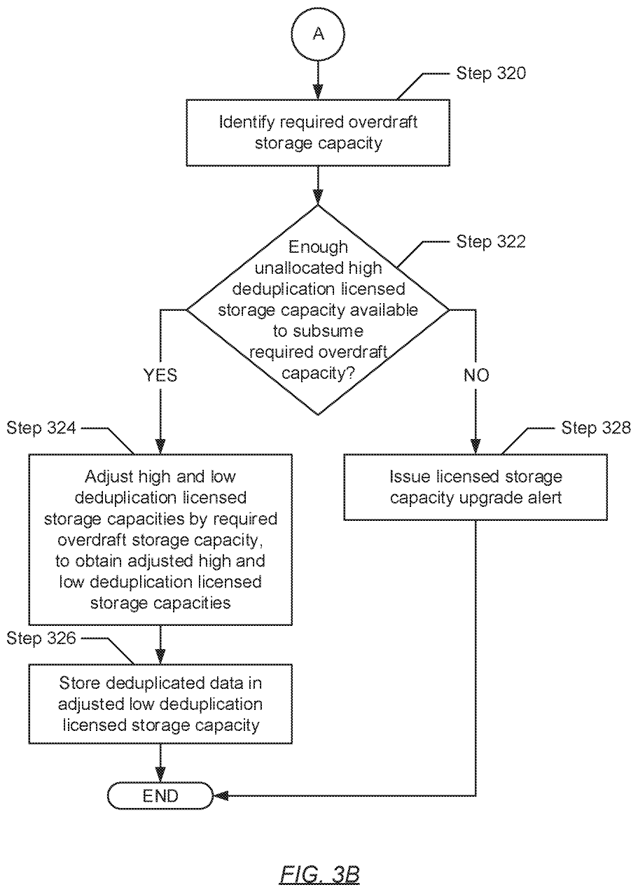

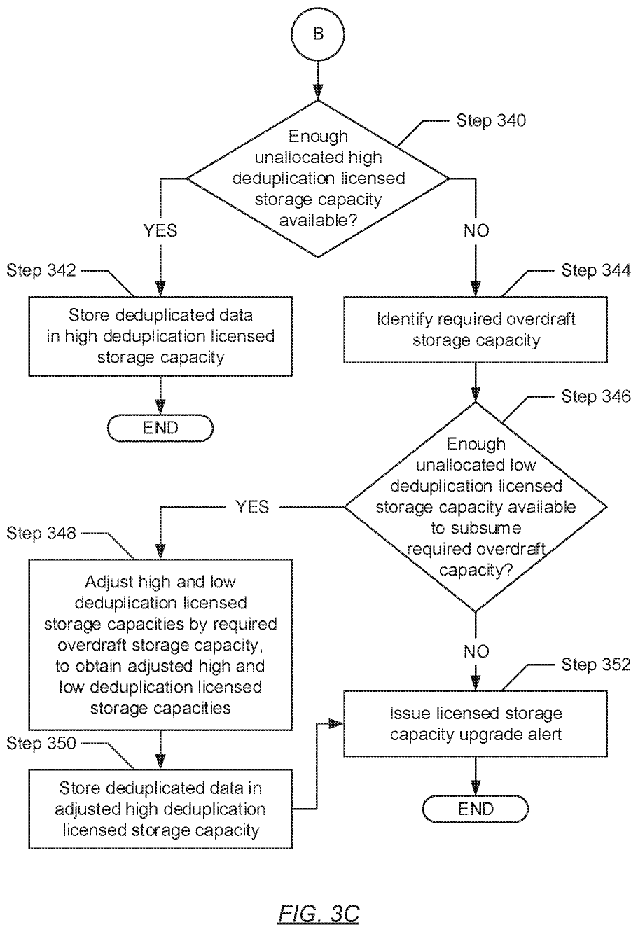

In one embodiment of the invention, the DPA (206) may be a computer program or process (i.e., an instance of a computer program) that executes on the underlying hardware of the BSS (200). Specifically, the DPA (206) may be a computer program or process tasked with dynamically managing the licensed storage capacities of the LSP (210) (described below) in accordance with one or more embodiments of the invention (see e.g., FIGS. 3A-3C). To that end, the DPA (206) may include functionality to: store the deduplicated data in an appropriate partition of the LSP (210) based at least on a relation between the determined deduplication ratio, associated with the deduplicated data, and a deduplication ratio threshold; manage overdrafts between different tiers of licensed storage capacities; and issue alerts when further licensed storage capacity needs to be procured.

In one embodiment of the invention, the SAA (208) may be a computer program or process(i.e., an instance of a computer program) that executes on the underlying hardware of the BSS (200). Specifically, the SAA (208) may be a computer program or process tasked with providing analytic information pertaining to the LSP (210). Subsequently, the SAA (208) may include functionality to: monitor the properties and performance of the LSP (210); generate statistics and/or metrics based on the monitoring; compound the statistics and/or metrics into auto-support reports; and provide these reports to the appropriate external party (e.g., the PCS (not shown), one or more user clients (not shown), etc.). The SAA (208) may additional issue alerts based on the triggering of exception events.

In one embodiment of the invention, the above-mentioned auto-support reports may disclose detailed configuration and performance information surrounding the LSP (210). These reports may be periodically generated and transmitted, thereafter, to the PCS and/or one or more user clients (not shown). Further, these reports may serve to aid any trouble-shooting or debugging processes regarding the LSP (210). Information detailed in an auto-support report may include, but is not limited to: general information (e.g., storage model type, system serial number, installed hardware, media access control (MAC) addresses, etc.), software information (e.g., operating system version, uptime, number of reboots, licenses, etc.), hardware information (e.g., power supply specifications, memory and computer processing resources, storage topology, etc.), filesystem statistics, filesystem compression information (e.g., deduplication statistics), server usage, network statistics, operating system logs, and kernel information.

In one embodiment of the invention, the LSP (210) may represent a logical or virtual aggregation of storage capacity formed from one or more physical. storage devices (212A-212N). The one or more physical storage devices (212A-212N) may be of varying capacities and types. Further, each physical storage device (212A-212N) may be implemented using persistent (i.e., non-volatile) storage. Examples of persistent storage include, but are not limited to: optical storage, magnetic storage, NAND Flash Memory, NOR Flash Memory, Magnetic Random Access Memory (M-RAM), Spin Torque Magnetic RAM (ST-MRAM), Phase Change Memory (PCM), or any other storage defined as non-volatile Storage Class Memory (SCM), In one embodiment of the invention, the LSP (210) may further include one or more physical storage expansion slots (214A-214N), thereby permitting the installation of additional physical storage devices (not shown) to augment the aggregated storage capacity, if necessary. The LSP (210) is described in further detail below with respect to FIG. 2B.

FIG. 2B shows a logical storage pool (LSP) in accordance with one or more embodiments of the invention. As described above, the LSP (210) may represent a logical or virtual aggregation of storage capacity formed from one or more physical storage devices. The total storage capacity across all physical storage devices, constituting the LSP (210), may be referred hereinafter as the storage capacity maximum (SCM) (220). For example, should the LSP (210) form from five physical storage devices that include 10 TB, 100 TB, 35 TB, 70 TB, and 120 TB storage capacities, respectively, then the SCM (220) would represent the sum of the various individual storage capacities (i.e., 10 TB+100 TB+35 TB+70 TB+120 TB=335 TB).

In one embodiment of the invention, the SCM (220) may be partitioned into licensed storage capacity (LSC) (222, 224) and unlicensed storage capacity (USC) (226). The LSC (222, 224) may refer to a first subtotal storage capacity implemented across a first subset of the physical storage device(s) constituting the LSP (210). Further, the LSC (222, 224) may pertain to storage capacity that may be procured through capacity licensing. Capacity licensing may refer to a licensing model whereby a license fee may be charged in return for an amount of protected storage capacity (i.e., LSC (222, 224)) that backup data may consume. On the other hand, the USC (226) may refer to a second subtotal storage capacity implemented across a second subset of the physical storage device(s) constituting the LSP (210). More specifically, the USC (226) may pertain to storage capacity that has yet to be provisioned through capacity licensing.

In one embodiment of the invention, the LSC (222, 224) may be further partitioned into high deduplication LSC (222) and low deduplication LSC (224). High deduplication LSC (222) may refer to a subset of the LSC designated for the consolidation of data that dedupes well (i.e., data associated with a high deduplication ratio following subjection to the data deduplication process). In contrast, low deduplication. LSC (224) may refer to a remainder of the LSC designated for the consolidation of data that does not dedupe well (i.e., data associated with a low deduplication ratio following subjection to the data deduplication process), Examples of data of the latter classification include, but are not limited to, pre-encrypted and/or pre-compressed data, database transaction logs, audio and/or video files, engineering drawings, closed-circuit television (CCTV) data, and streaming data.

In one embodiment of the invention, the high deduplication LSC (222) may encompass allocated high deduplication LSC (not shown) and unallocated high deduplication LSC (not shown). Allocated high deduplication LSC may refer to a subset of the high deduplication LSC (222) to which data has already been written (through the course of past backup operations). Conversely, unallocated high deduplication LSC may refer to a remaining subset of the high deduplication LSC (222) to which data has yet to be written. Similarly, the low deduplication LSC (224) may encompass allocated low deduplication LSC (not shown) and unallocated low deduplication LSC (not shown).

In one embodiment of the invention, backup data may require the consumption of more high deduplication LSC (222) or low deduplication LSC (224) than that which may be available. In such an embodiment, unallocated LSC may be overdrawn from one LSC partition to subsume (or cover) the lack of storage capacity in another LSC partition. That is, should it be determined that there is insufficient unallocated high deduplication LSC to consolidate submitted backup data, then a difference (or delta) LSC may be calculated, which may represent the amount of unallocated. LSC the high deduplication LSC may be lacking. Thereafter, the obtained difference/delta LSC may be compared with the unallocated low deduplication. LSC to determine whether there is enough of the latter to assist in the consolidation of the submitted backup data. If there indeed is sufficient unallocated low deduplication LSC, storage capacity equivalent to the difference/delta LSC may be overdrawn (i.e., transferred) from the unallocated low deduplication. LSC to be represented as unallocated high deduplication LSC. The augmented unallocated high deduplication LSC may then be used to consolidate the submitted backup data. Similarly, should it be determined that there is insufficient unallocated low deduplication LSC to consolidate submitted data, and sufficient unallocated high deduplication LSC is available to subsume (or cover) the difference/delta LSC that the unallocated low deduplication LSC may be lacking, then a difference/delta LSC equivalent of the unallocated high deduplication LSC may be overdrawn therefrom to the unallocated low deduplication LSC. In one embodiment of the invention, the difference (or delta) LSC may also be referred to as overdraft LSC (228). Furthermore, following transfer of the overdraft LSC (228), the total LSC defining each LSC partition may be adjusted to account for the addition or subtraction of overdraft LSC (228) to/from the impacted LSC partitions.

While FIG. 2B shows a LSP (210) partitioned into high and low deduplication LSCs (222, 224), other LSP (210) configurations may be used without departing from the scope of the invention. For example, the LSP (210) may alternatively be partitioned into high and low performance LSCs (not shown), where: (a) the high performance LSC may be used to consolidate high priority and/or high access data, and may be implemented using, for example, low-latency, high input-output operations per second (IOPS) physical storage devices; whereas (b) the low performance LSC may be used to consolidate low priority and/or low access data, and may be implemented using, for example, moderate-to-high latency, low-to-moderate IOPS physical storage devices. More generally, in one embodiment of the invention, the LSP (210) may be partitioned into different tiers of storage capacity distinguished through other metrics or properties (e.g., by geographic location, by cost, etc.).

FIGS. 3A-3C show flowcharts describing a method for dynamically managing storage capacity in accordance with one or more embodiments of the invention. The various steps outlined below may be performed by the backup storage system (BSS) (see e.g., FIG. 2A). Further, while the various steps in the flowcharts are presented and described sequentially, one of ordinary skill will appreciate that some or all steps may be executed in different orders, may be combined or omitted, and some or all steps may be executed in parallel.

Turning to FIG. 3A, in Step 300, a data storage request is received. In one embodiment of the invention, the data storage request may have been submitted by a production computing system (PCS) (see e.g., FIG. 1) operatively connected to the BSS. Further, the data storage request may include original data (i.e., pre-deduplication data) directed to the BSS for backup, archiving, and/or disaster recovery purposes.

In Step 302, the original data (received via the data storage request in Step 300) is subjected through the data deduplication process. In one embodiment of the invention, by way of the data deduplication process, redundant information in the original data is removed prior to consolidation, thereby compressing the original data, Further, following the data deduplication process, deduplicated data (i.e., representative of the compressed original data) may be obtained, as well as a deduplication ratio (DR) that may quantify the effectiveness of the data deduplication process on the original data, The DR relates the storage capacity required to store the original data to the storage capacity required to store the deduplicated data. For example, had the original data required 10 Terabytes (TB) of storage, whereas the deduplicated data requires 1 TB, the resulting DR would be 10:1 (granting a 90% savings in storage capacity).

In Step 304, a determination is made as to whether the DR (obtained in Step 302) is less than a deduplication ratio threshold. In one embodiment of the invention, the deduplication ratio threshold may define a criterion, which when met or not, steers the consolidation of the deduplicated data onto an appropriate tier of licensed storage capacity (LSC) (e.g., a low deduplication LSC or a high deduplication LSC). Further, the deduplication ratio threshold may be determined based on analytic information rendered by the storage auto-support agent (SAA) (see e.g., FIG. 2A), which may be executing on the BSS. By way of an example, the deduplication ratio threshold may be set as 4:1. In one embodiment of the invention, if it is determined that the deduplication ratio is less than (or below) the deduplication ratio threshold, then the process may proceed to Step 306. On the other hand, in another embodiment of the invention, if it is alternatively determined that the deduplication ratio exceeds (or is equal to) the deduplication ratio threshold, then the process may alternatively proceed to Step 340 (see e.g., FIG. 3C).

In Step 306, after determining (in Step 304) that the deduplication ratio (obtained in Step 302) is less than a deduplication ratio threshold, another determination is made as to whether there is sufficient unallocated low deduplication. LSC available to consolidate the deduplicated data (also obtained in Step 302). In one embodiment of the invention, unallocated low deduplication LSC may refer to free low deduplication LSC to which data may be written. Further, the low deduplication LSC may represent a logical or virtual partition of the logical storage pool (LSP) (see e.g., FIG. 2B), which reserves storage capacity across one or more physical storage devices for the consolidation of data that does not dedupe well (i.e., deduplicated data associated with a low deduplication ratio) (e.g., pre-encrypted and/or pre-compressed data, database transaction logs, audio and/or video files, engineering drawings, closed-circuit television (CCTV) data, streaming data, etc.). In one embodiment of the invention, if it is determined that the unallocated low deduplication LSC is equal to or greater than the storage capacity required to consolidate the deduplicated data, then the process may proceed to Step 308, On the other hand, if it is alternatively determined that the unallocated low deduplication LSC is less than the storage capacity required to consolidated the deduplicated data, then the process may alternatively proceed to Step 320 (see e.g., FIG. 3B),

In Step 308, after determining (in Step 306) that there is sufficient unallocated low deduplication. LSC to consolidate the deduplicated data. (obtained in Step 302), the deduplicated data is stored (or written) therein. In one embodiment of the invention, the deduplicated data may be written to one physical. storage device. In another embodiment of the invention, the deduplicated data may be written across multiple physical storage devices.

Turning to FIG. 3B, in Step 320, after determining (in Step 306) that there is insufficient unallocated deduplication LSC to consolidate the deduplicated data (obtained in Step 302), a required overdraft storage capacity is identified. In one embodiment of the invention, the required overdraft storage capacity may represent a difference (or delta) in licensed storage capacity needed to be overdrawn from the high deduplication LSC in order to accommodate consolidation of the deduplicated data. By way of an example, if the storage capacity required to consolidate the deduplicated data is found to be 20 Terabytes (TB), however, the remaining unallocated low deduplication LSC only measures at 5 TB, then the overdraft storage capacity needed to accommodate the deduplicated data is 20 TB minus 5 TB, or 15 TB, which would need to be overdrawn from the high deduplication LSC, if available.

In Step 322, a determination is made as to whether there is sufficient unallocated high deduplication LSC available to subsume (or cover) the required overdraft storage capacity (identified in Step 320). In one embodiment of the invention, unallocated high deduplication LSC may refer to free high deduplication LSC to which data may be written. Though reserved for data that does dedupe well (i.e., deduplicated data associated with a high deduplication ratio), unallocated high deduplication LSC remains, generally, as unused LSC that may be consumed by any data submitted for consolidation on the BSS. Accordingly, in one embodiment of the invention, if it is determined that the unallocated high deduplication LSC is equal to or greater than the required overdraft storage capacity, then the process may proceed to Step 324. On the other hand, in another embodiment of the invention, if it is alternatively determined that the unallocated high deduplication LSC is less than the required overdraft storage capacity, then the process may alternatively proceed to Step 328.

In Step 324, after determining (in Step 322) that there is sufficient unallocated high deduplication LSC to subsume the required overdraft storage capacity (identified in Step 320), an adjustment of the high and low deduplication LSCs is performed. Specifically, in one embodiment of the invention, the high deduplication LSC may be adjusted by reducing its total LSC by the required overdraft storage capacity (identified in Step 320). Conversely, the low deduplication LSC may be adjusted by augmenting its total LSC by the required overdraft storage capacity. For example, assume the total LSC (i.e., defining allocated and unallocated LSC) for the high deduplication LSC is initially at 50 TB, whereas the total LSC for the low deduplication LSC is initially at 30 TB, Further, insufficient unallocated low deduplication LSC is available to consolidate deduplicated data. Subsequently, an overdraft storage capacity of 10 TB is found to be required, which the unallocated high deduplication LSC can cover. Accordingly, the total LSC for the high deduplication LSC is adjusted by subtracting the overdraft storage capacity, thereby obtaining an adjusted high deduplication LSC of 50 TB minus 10 TB, or 40 TB, On the other hand, the total LSC for the low deduplication LSC is adjusted by adding the overdraft storage capacity, thereby obtaining an adjusted low deduplication. LSC of 30 TB plus 10 TB, or 40 TB.

In Step 326, the deduplicated data (obtained in Step 302) is subsequently stored in the adjusted low deduplication LSC. As mentioned above, in one embodiment of the invention, the adjusted low deduplication LSC may represent a resized low deduplication LSC, which had overdrawn—from the unallocated high deduplication LSC—the difference (or delta) licensed storage capacity needed to consolidate the deduplicated data. Further, in one embodiment of the invention, the deduplicated data may be written to one physical storage device, In another embodiment of the invention, the deduplicated data may be written across multiple physical storage devices.

In Step 328, after alternatively determining (in Step 322) that there is insufficient unallocated high deduplication LSC to subsume the required overdraft storage capacity (identified in Step 320), an alert is issued. Specifically, in one embodiment of the invention, a licensed storage capacity upgrade alert may be issued, which may be directed to notifying users and/or administrators of the BSS that additional capacity licenses would need to be procured. Based on the type of additional capacity licenses that may be procured and subsequently installed, the total LSC for the high deduplication LSC, the total LSC for the low deduplication LSC, or a combination thereof, may be updated. In one embodiment of the invention, the licensed storage capacity upgrade alert may be issued before the determination performed in Step 322. That is, the alert may be issued when either allocated low deduplication LSC or allocated high deduplication LSC has reached a predetermined percentage of the total LSC for their respective LSC partitions, For example, an alert may be issued when the allocated (or consumed) low deduplication. LSC occupies eighty percent (80%) of the total storage capacity designated as low deduplication LSC.

Turning to FIG. 3C, in Step 340, after alternatively determining (in Step 304) that the deduplication ratio (obtained in Step 302) equals or exceeds the deduplication ratio threshold, another determination is made as to whether sufficient unallocated high deduplication LSC is available to consolidate the deduplicated data (also obtained in Step 302). In one embodiment of the invention, unallocated high deduplication LSC may refer to free high deduplication LSC to which data may be written. Further, the high deduplication LSC may represent a logical or virtual partition of the logical storage pool (LSP) (see e.g., FIG. 2B), which reserves storage capacity across one or more physical storage devices for the consolidation of data that does dedupe well (i.e., deduplicated data associated with a high deduplication ratio). Subsequently, in one embodiment of the invention, if it is determined that the unallocated high deduplication LSC is equal to or greater than the storage capacity required to consolidate the deduplicated data, then the process may proceed to Step 342. On the other hand, if it is alternatively determined that the unallocated high deduplication LSC is less than the storage capacity required to consolidated the deduplicated data, then the process may alternatively proceed to Step 344.

In Step 342, after determining Step 340) that there is sufficient unallocated high deduplication LSC to consolidate the deduplicated data (obtained in Step 302), the deduplicated data is stored (or written) therein. In one embodiment of the invention, the deduplicated data may be written to one physical. storage device. In another embodiment of the invention, the deduplicated data may be written across multiple physical storage devices.

In Step 344, after alternatively determining (in Step 340) that there is insufficient unallocated high deduplication LSC to consolidate the deduplicated data (obtained in Step 302), a required overdraft storage capacity is identified. In one embodiment of the invention, the required overdraft storage capacity may represent a difference (or delta) in licensed storage capacity needed to be overdrawn from the low deduplication LSC in order to accommodate consolidation of the deduplicated data. By way of an example, if the storage capacity required to consolidate the deduplicated data is found to be 20 Terabytes (TB), however, the remaining unallocated high deduplication LSC only measures at 5 TB, then the overdraft storage capacity needed to accommodate the deduplicated data is 20 TB minus 5 TB, or 15 TB, which would need to be overdrawn from the low deduplication LSC, if available.

In Step 346, a determination is made as to whether there is sufficient unallocated low deduplication LSC available to subsume (or cover) the required overdraft storage capacity (identified in Step 344). In one embodiment of the invention, unallocated low deduplication LSC may refer to free low deduplication LSC to which data may be written. Though reserved for data that does not dedupe well (i.e., deduplicated data associated with a low deduplication ratio), unallocated low deduplication LSC remains, generally, as unused LSC that may be consumed by any data submitted for consolidation on the BSS. Accordingly, in one embodiment of the invention, if it is determined that the unallocated low deduplication LSC is equal to or greater than the required overdraft storage capacity, then the process may proceed to Step 348. On the other hand, in another embodiment of the invention, if it is alternatively determined that the unallocated low deduplication LSC is less than the required overdraft storage capacity, then the process may alternatively proceed to Step 352.

In Step 348, after determining (in Step 346) that there is sufficient unallocated low deduplication. LSC to subsume the required overdraft storage capacity (identified in Step 344), an adjustment of the high and low deduplication LSCs is performed. Specifically, in one embodiment of the invention, the low deduplication LSC may be adjusted by reducing its total LSC by the required overdraft storage capacity (identified in Step 344). Conversely, the high deduplication LSC may be adjusted by augmenting its total LSC by the required overdraft storage capacity. For example, assume the total LSC (i.e., defining allocated and unallocated LSC) for the high deduplication LSC is initially at 50 TB, whereas the total LSC for the low deduplication. LSC is initially at 30 TB. Further, insufficient unallocated high deduplication LSC is available to consolidate deduplicated data. Subsequently, an overdraft storage capacity of 10 TB is found to be required, which the unallocated low deduplication. LSC can cover. Accordingly, the total LSC for the high deduplication LSC is adjusted by adding the overdraft storage capacity, thereby obtaining an adjusted high deduplication LSC of 50 TB plus 10 TB, or 60 TB. On the other hand, the total LSC for the low deduplication LSC is adjusted by subtracting the overdraft storage capacity, thereby obtaining an adjusted low deduplication LSC of 30 TB minus 10 TB, or 20 TB.

In Step 350, the deduplicated data (obtained in Step 302) is subsequently stored in the adjusted high deduplication LSC. As mentioned above, in one embodiment of the invention, the adjusted high deduplication LSC may represent a resized high deduplication LSC, which had overdrawn—from the unallocated low deduplication LSC—the difference delta) licensed storage capacity needed to consolidate the deduplicated data. Further, in one embodiment of the invention, the deduplicated data may be written to one physical storage device. In another embodiment of the invention, the deduplicated data may be written across multiple physical storage devices.

In Step 352, after alternatively determining (in Step 346) that there is insufficient unallocated low deduplication LSC to subsume the required overdraft storage capacity (identified in Step 344), an alert is issued. Specifically, in one embodiment of the invention, a licensed storage capacity upgrade alert may be issued, which may be directed to notifying users and/or administrators of the BSS that additional capacity licenses would need to be procured. Based on the type of additional capacity licenses that may be procured and subsequently installed, the total LSC for the high deduplication LSC, the total LSC for the low deduplication LSC, or a combination thereof, may be updated. In one embodiment of the invention, the licensed storage capacity upgrade alert may be issued before the determination performed in Step 346. That is, the alert may be issued when either allocated low deduplication LSC or allocated high deduplication LSC has reached a predetermined percentage of the total LSC for their respective LSC partitions. For example, an alert may be issued when the allocated (or consumed) low deduplication LSC occupies eighty percent (80%) of the total storage capacity designated as low deduplication LSC.

FIG. 4 shows a computing system in accordance with one or more embodiments of the invention, The computing system (400) may include one or more computer processors (402), non-persistent storage (404) (e.g., volatile memory, such as random access memory (RAM), cache memory), persistent storage (406) (e.g., a hard disk, an optical drive such as a compact disk (CD) drive or digital versatile disk (DVD) drive, a flash memory, etc.), a communication interface (412) (e.g., Bluetooth interface, infrared interface, network interface, optical interface, etc.), input devices (410), output devices (408), and numerous other elements (not shown) and functionalities. Each of these components is described below.

In one embodiment of the invention, the computer processor(s) (402) may be an integrated circuit for processing instructions, For example, the computer processor(s) may be one or more cores or micro-cores of a processor. The computing system (400) may also include one or more input devices (410), such as a touchscreen, keyboard, mouse, microphone, touchpad, electronic pen, or any other type of input device. Further, the communication interface (412) may include an integrated circuit for connecting the computing system (400) to a network (not shown) (e.g., a local area network (LAN), a wide area network (WAN) such as the Internet, mobile network, or any other type of network) and/or to another device, such as another computing device.

In one embodiment of the invention, the computing system (400) may include one or more output devices (408), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (402), non-persistent storage (404), and persistent storage (406). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention.

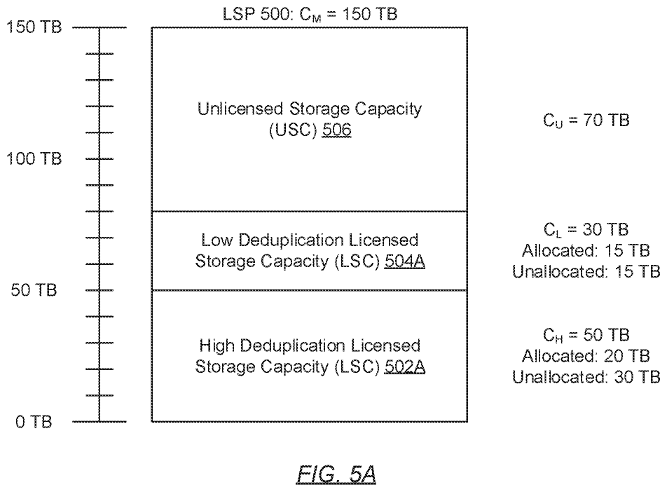

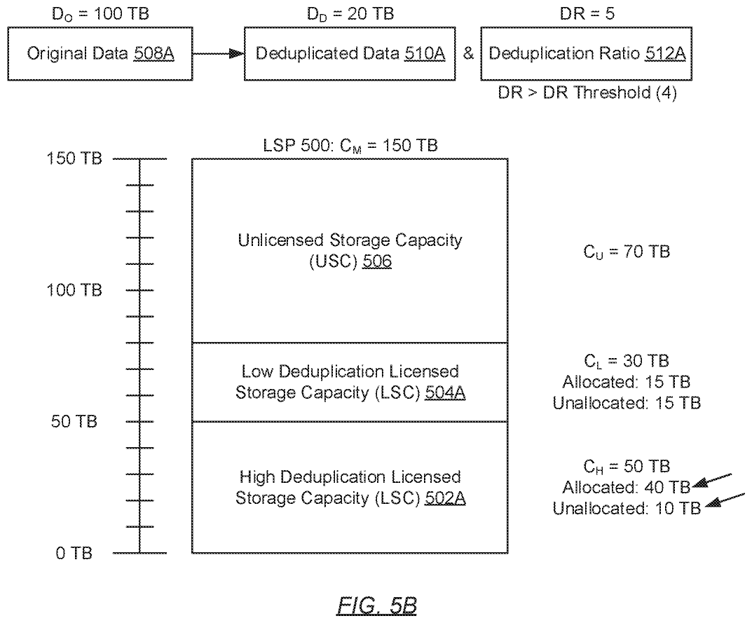

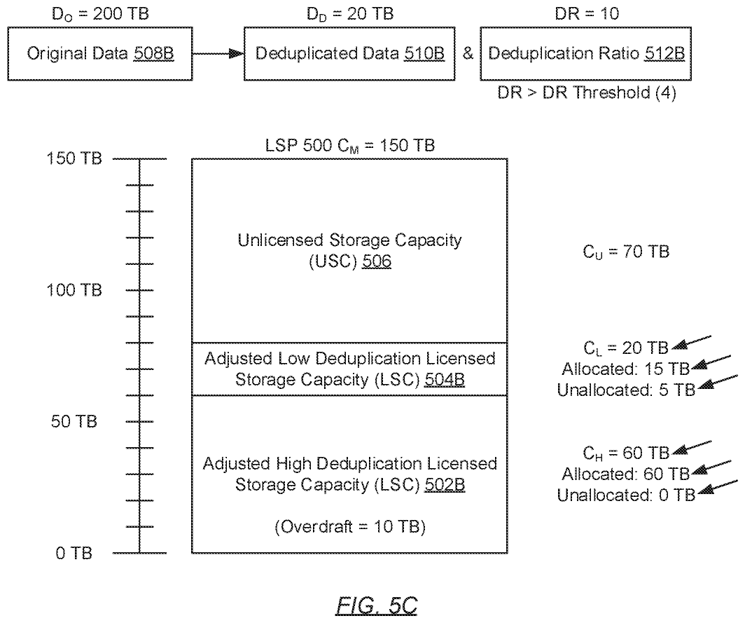

FIGS. 5A-5C show an example scenario in accordance with one or more embodiments of the invention, The following example, presented in conjunction with components shown in FIGS. 5A-5C, is for explanatory purposes only and not intended to limit the scope of the invention.

Turning to the example, let us consider an initial state of a logical storage pool (LSP) (500) illustrated in FIG. 5A. The total storage capacity, or storage capacity maximum (SCM), of the LSP (500) is 150 Terabytes (TB). The SCM is divided up into three partitions: (a) a 50 TB high deduplication licensed storage capacity (LSC) (502A); (b) a 30 TB low deduplication LSC (504A); and (c) a 70 TB unlicensed storage capacity (USC) (506). Further, of the 50 TB high deduplication LSC (502A), 20 TB is allocated (i.e., consumed) LSC and 30 TB is unallocated (i.e., free) LSC; and of the 30 TB low deduplication LSC (504A), 15 TB is allocated LSC whereas 15 TB is unallocated LSC.

Turning to FIG, 5B, assume, at this point, a first original data (508A) is submitted for consolidation on the backup storage system (BSS). The storage capacity needed to consolidate the first original data (508A), before data deduplication, is measured at 100 TB. After subjection through the data deduplication process, however, a first deduplicated data (510A) is obtained from the first original data (508A), which measures at 20 TB. Subsequently, a first deduplication ratio (DR) (512A) obtained through the compression of the first original data (508A) is calculated as 100 TB divided by 20 TB, or 5:1.

Furthermore, assume a DR threshold is identified as being set to 4:1. In one embodiment of the invention, the DR threshold may serve as a classification boundary that indicates whether the deduplicated data (510A) should be consolidated in the high deduplication LSC (502A) or the low deduplication LSC (504A) based on the associated DR (512A). Following a comparison, it is determined that the first DR (512A) exceeds the DR threshold (i.e., 5:1>4:1). Based on this determination, the first deduplicated data (510A) is identified as data that dedupes well and, accordingly, should be consolidated in the high. deduplication LSC (502A). Hereinafter, a check confirms that sufficient unallocated high deduplication LSC (i.e., 30 TB) is available to consolidate the first deduplicated data (510A) (i.e., 20 TB). Based on the confirmation, the first deduplicated data (510A) is stored in the high deduplication LSC (502A). With the consolidation of the first deduplicated data (510A), the measured allocated high deduplication LSC rises to 40 TB (i.e., the initial 20 TB plus the 20 TB representative of the first deduplicated data), whereas the unallocated high deduplication LSC lowers to 10 TB (i.e., the initial 30 TB minus the 20 TB representative of the first deduplicated data).

Turning to FIG. 5C, assume, thereafter, a second original data (508B) is submitted for consolidation on the BSS. The storage capacity needed to consolidate the second original data (508B), before data deduplication, is measured at 200 TB. After subjection through the data deduplication process, however, a second deduplicated data (510B) is obtained from the second original data (508B), which measures at 20 TB. Subsequently, a second DR (512B) obtained through the compression of the second original data (508B) is calculated as 200 TB divided by 20 TB, or 10:1.

Following another comparison, it is determined that the second DR (512B) exceeds the DR threshold (i.e., 10:1>4:1). Based on this determination, the second deduplicated data (510B) is also identified as data that dedupes well and, accordingly, should also be consolidated in the high deduplication LSC (502A). However, this time around, a check confirms that insufficient unallocated high deduplication LSC (i.e., 10 TB) is available to consolidate the second deduplicated. data (510B) (i.e., 20 TB). Based on this confirmation, the low deduplication LSC (504A) is assessed to determine whether there is sufficient unallocated low deduplication LSC to subsume (or cover) the remaining 10 TB (i.e., difference/delta or overdraft LSC) needed to consolidate the second deduplicated data (510B).

Based on the assessment, it is determined that there indeed is sufficient unallocated low deduplication LSC (i.e., the initial 15 TB) to subsume the overdraft LSC (i.e., 10 TB). Accordingly, an overdraft LSC equivalent of the unallocated low deduplication LSC is overdrawn into the high deduplication LSC (502A). This leads to an adjustment of the LSC defining the low deduplication LSC (504B) as well as the high deduplication LSC (502B). Specifically, the low deduplication LSC (504B), overall, is adjusted to encompass 20 TB (i.e., the initial total 30 TB minus 10 TB representative of the overdraft LSC). The unallocated low deduplication LSC is also diminished from 15 TB (initially) to 5 TB (i.e., subtracting 10 TB, representative of the overdraft LSC, from the initial capacity), Conversely, the overall high deduplication LSC (502B) is augmented from the initial 50 TB to an adjusted 60 TB, which includes the additional 10 TB overdrawn from the low deduplication LSC.

Further, in consolidating the second deduplicated data (510B) therein, the allocated high deduplication LSC rises to 60 TB (i.e., 40 TB after consolidating the first deduplicated data (510A) plus 20 TB needed to consolidate the second deduplicated data (510B)), while the unallocated high deduplication LSC drops to 0 TB (i.e., 10 TB after consolidating the first deduplicated data (510A) plus 10 TB overdrawn from the unallocated low deduplication LSC minus 20 TB needed to consolidate the second deduplicated data (510B)). With all high deduplication LSC (502B) consumed by deduplicated data written thereto, an LSC upgrade alert may be issued to notify users and/or administrators of the BSS that further capacity licenses would need to be procured. Upon procurement and installation, a portion or all of the USC (506) may be re-designated as high deduplication LSC and/or low deduplication LSC.

Embodiments of the invention relate to a method and system for dynamic data protection. Dynamic data protection may refer to a flexible framework for protecting backup workloads of varying characteristics. Prior to the invention. disclosed herein, no distinction would be made between, for example, data that may dedupe well versus data that may not dedupe well, with respect to backup management and/or licensing, That is, current data protection (or backup) systems are not aware of the characteristics of the data that which they consolidate, and as such., these systems remain unresponsive to changing workloads. The invention disclosed herein addresses these shortcomings by assessing incoming data characteristics and consolidating the data in characteristic-appropriate storage capacities.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for storing data, comprising:
receiving a first data storage request comprising a first original data;
deduplicating the first original data to obtain a first deduplicated data and a first deduplication ratio;
making a first determination that the first deduplication ratio is below a deduplication ratio threshold;
making a second determination, based on the first determination, that insufficient unallocated low deduplication licensed storage capacity (LSC) is available to consolidate the first deduplicated data;
identifying, based on the second determination, a first required overdraft storage capacity;
making a third determination that sufficient unallocated high deduplication LSC is available to subsume the first required overdraft storage capacity;
adjusting, based on the third determination, the low deduplication LSC and the high deduplication LSC by the first required overdraft storage capacity; and
storing the first deduplicated data in the low deduplication LSC.

2. The method of claim 1, wherein the first required overdraft storage capacity is a difference between a required LSC needed to consolidate the first deduplicated data and an available LSC representing the unallocated low deduplication LSC.

3. The method of claim 1, further comprising:
receiving a second data storage request comprising a second original data;
deduplicating the second original data to obtain a second deduplicated data and a second deduplication ratio;
making a fourth determination that the second deduplication ratio is below the deduplication ratio threshold;
making a fifth determination, based on the fourth determination, that insufficient unallocated low deduplication LSC is available to consolidate the second deduplicated data;
identifying, based on the fifth determination, a second required overdraft storage capacity;
making a sixth determination that insufficient unallocated high deduplication LSC is available to subsume the second required overdraft storage capacity; and
issuing, based on the sixth determination, a LSC upgrade alert.

4. The method of claim 1, further comprising:
receiving a second data storage request comprising a second original data;
deduplicating the second original data to obtain a second deduplicated data and a second deduplication ratio;
making a fourth determination that the second deduplication ratio exceeds the deduplication ratio threshold;
making a fifth determination, based on the fourth determination, that sufficient unallocated high deduplication LSC is available to consolidate the second deduplicated data; and
storing, based on the fifth determination, the second deduplicated data in the high deduplication LSC.

5. The method of claim 1, further comprising:
receiving a second data storage request comprising a second original data;
deduplicating the second original data to obtain a second deduplicated data and a second deduplication ratio;
making a fourth determination that the second deduplication ratio exceeds the deduplication ratio threshold;
making a fifth determination, based on the fourth determination, that insufficient unallocated high deduplication LSC is available to consolidate the second deduplicated data;
identifying, based on the fifth determination, a second required overdraft storage capacity;
making a sixth determination that sufficient unallocated low deduplication LSC is available to subsume the second required overdraft storage capacity;
adjusting, based on the sixth determination, the high deduplication LSC and the low deduplication LSC by the second required overdraft storage capacity; and
storing the second deduplicated data in the high deduplication LSC.

6. The method of claim 1, further comprising:
receiving a second data storage request comprising a second original data;
deduplicating the second original data to obtain a second deduplicated data and a second deduplication ratio;
making a fourth determination that the second deduplication ratio exceeds the deduplication ratio threshold;
making a fifth determination, based on the fourth determination, that insufficient unallocated high deduplication LSC is available to consolidate the second deduplicated data;
identifying, based on the fifth determination, a second required overdraft storage capacity;
making a sixth determination that insufficient unallocated low deduplication. LSC is available to subsume the second required overdraft storage capacity; and
issuing, based on the sixth determination, a LSC upgrade alert.

7. The method of claim 1, further comprising:
receiving a second data storage request comprising a second original data;
deduplicating the second original data to obtain a second deduplicated data and a second deduplication ratio;
making a fourth determination that the second deduplication ratio is below the deduplication ratio threshold;
making a fifth determination, based on the fourth determination, that sufficient unallocated low deduplication LSC is available to consolidate the second deduplicated data; and
storing, based on the fifth determination, the second deduplicated data in the low deduplication LSC.

8. A system, comprising:
a computer processor; and
a dynamic protection agent (DPA) executing on the computer processor, and programmed to:
receive a first data storage request comprising a first original data;
obtain a first deduplicated data and a first deduplication ratio following deduplication of the first original data;
make a first determination that the first deduplication ratio is below a deduplication ratio threshold;
make a second determination, based on the first determination, that insufficient unallocated low deduplication licensed storage capacity (LSC) is available to consolidate the first deduplicated data;
identify, based on the second determination, a first required overdraft storage capacity;
make a third determination that sufficient unallocated high deduplication LSC is available to subsume the first required overdraft storage capacity;
adjust, based on the third determination, the low deduplication LSC and the high deduplication LSC by the first required overdraft storage capacity; and
store the first deduplicated data in the how deduplication LSC.

9. The system of claim 8, further comprising:
a data deduplication agent (DDA) executing on the computer processor and operatively connected to the DPA,
wherein the DPA is programmed to:
provide the first original data to the DDA; and
receive, from the DDA, the first deduplicated data and the first deduplication ratio after the DDA has deduplicated the first original data.

10. The system of claim 8, further comprising:
a logical storage pool (LSP) formed from a plurality of physical storage devices operatively connected to the computer processor,
wherein a low deduplication LSC comprises a first portion of the LSP,
wherein a high deduplication LSC comprises a second portion of the LSP.

11. The system of claim 10, further comprising:
an unlicensed storage capacity (USC) comprising a third portion of the LSP.

12. The system of claim 10, wherein the DPA and the LSP are part of a backup storage system (BSS).

13. The system of claim 12, further comprising:
a production computing system (PCS) operatively connected to the BSS,
wherein the first data storage request is submitted by the PCS.

14. A non-transitory computer readable medium (CRM) comprising computer readable program code, which when executed by a computer processor, enables the computer processor to:
receive a first data storage request comprising a first original data;
obtain a first deduplicated data and a first deduplication ratio following deduplication of the first original data;
make a first determination that the first deduplication ratio is below a deduplication ratio threshold;
make a second determination, based on the first determination, that insufficient unallocated low deduplication licensed storage capacity (LSC) is available to consolidate the first deduplicated data;
identify, based on the second determination, a first required overdraft storage capacity;
make a third determination that sufficient unallocated high deduplication LSC is available to subsume the first required overdraft storage capacity;
adjust, based on the third determination, the low deduplication LSC and the high deduplication LSC by the first required overdraft storage capacity; and
store the first deduplicated data in the low deduplication LSC.

15. The non-transitory CRM of claim 14, wherein the first required overdraft storage capacity is a difference between a required LSC needed to consolidate the first deduplicated data and an available LSC representing the unallocated low deduplication LSC.

16. The non-transitory CRM of claim 14, further comprising computer readable program code, which when executed by the computer processor, enables the computer processor to:
receive a second data storage request comprising a second original data;
obtain a second deduplicated data and a second deduplication ratio following deduplication of the second original data;
make a fourth determination that the second deduplication ratio is below the deduplication ratio threshold;
make a fifth determination, based on the fourth determination, that insufficient unallocated low deduplication LSC is available to consolidate the second deduplicated data;
identify, based on the fifth determination, a second required overdraft storage capacity;
make a sixth determination that insufficient unallocated high deduplication LSC is available to subsume the second required overdraft storage capacity; and
issue, based on the sixth determination, a LSC upgrade alert.

17. The non-transitory CRM of claim 14, further comprising computer readable program code, which when executed the computer processor, enables the computer processor to:
receive a second data storage request comprising a second original data;
obtain a second deduplicated data and a second deduplication ratio following deduplication of the second original data;
make a fourth determination that the second deduplication ratio exceeds the deduplication ratio threshold;
make a fifth determination, based on the fourth determination, that sufficient unallocated high deduplication LSC is available to consolidate the second deduplicated data; and
store, based on the fifth determination, the second deduplicated data in the high deduplication LSC.

18. The non-transitory CRM of claim 14, further comprising computer readable program code, which when executed by the computer processor, enables the computer processor to:
receive a second data storage request comprising a second original data;
obtain a second deduplicated data and a second deduplication ratio following deduplication of the second original data;
make a fourth determination that the second deduplication ratio exceeds the deduplication ratio threshold;
make a fifth determination, based on the fourth determination, that insufficient unallocated high deduplication LSC is available to consolidate the second deduplicated data;
identify, based on the fifth determination, a second required overdraft storage capacity;
make a sixth determination that sufficient unallocated low deduplication LSC is available to subsume the second required overdraft storage capacity;
adjust, based on the sixth determination, the high deduplication LSC and the low deduplication LSC by the second required overdraft storage capacity; and
store the second deduplicated data in the high deduplication LSC.

19. The non-transitory CRM of claim 14, further comprising computer readable program code, which when executed by the computer processor, enables the computer processor to:
receive a second data storage request comprising a second original data;
obtain a second deduplicated data and a second deduplication ratio following deduplication of the second original data;
make a fourth determination that the second deduplication ratio exceeds the deduplication ratio threshold;
make a fifth determination, based on the fourth determination, that insufficient unallocated high deduplication LSC is available to consolidate the second deduplicated data;
identify, based on the fifth determination, a second required overdraft storage capacity;
make a sixth determination that insufficient unallocated low deduplication LSC is available to subsume the second required overdraft storage capacity; and
issue, based on the sixth determination, a LSC upgrade alert.

20. The non-transitory: CRM of claim 14, further comprising computer readable program. code, which when executed by the computer processor, enables the computer processor to:
receive a second data storage request comprising a second original data;
obtain a second deduplicated data and a second deduplication ratio following deduplication of the second original data;
make a fourth determination that the second deduplication ratio is below the deduplication ratio threshold;
make a fifth determination, based on the fourth determination, that sufficient unallocated low deduplication LSC is available to consolidate the second deduplicated data; and
store, based on the fifth determination, the second deduplicated data in the low deduplication LSC.
